(19) United States
(12) Patent Application Publication
(10) Pub. No.: US 2005/0121242 A1
(43) Pub. Date: Jun. 9, 2005

(54) Motor vehicle energy recovery system

(76) Inventor: Gerald M. Robinson, Burnaby (CA)

Correspondence Address: Vermette & Co.;Granville Square, 200 Granville Street, Suite 230, Box 40, Vancouver, BC, V6C 1S4, CA

(21) Appl. No.: 10/726,575

(22) Filed: Dec. 4, 2003

(51) Int. Cl. B62M 1/10

(52) U.S. Cl. 180/165

(57) ABSTRACT

A moveable vehicle energy recovery apparatus, which comprises an air capture unit operative to be mounted on the moveable vehicle in a position to capture oncoming air when the moveable vehicle is in motion, a fan rotatably mounted in the air capture unit and a generator coupled to the fan and operative to rotate in response to rotation of the fan and to generate power. The recovery apparatus provides additional energy from the air passing the vehicle.

### FIELD

The present invention relates to a system for recovering energy from the air moving past a moving vehicle when the latter is in motion.

### BACKGROUND

Fuel economy in moveable vehicles such as trucks and automobiles is becoming increasingly important given the rise in usage of energy and its resultant increasing cost. One way of saving on the cost of energy is energy recovery. On motor vehicles there are various ways of recovering energy such as utilizing the heat generated from braking or the energy imparted to a vehicle when it is going downhill. Such devices have failed to become established in the marketplace due to their capital cost and complexity of installation. In addition, the amount of power generated is intermittent depending on the number of hills and the amount of braking.

Accordingly, it is an object of the invention to provide an energy recovery system that is substantially continuously operative and can produce an amount of energy that is larger than conventional energy recovery systems.

### SUMMARY OF THE INVENTION

According to the invention there is provided a moveable vehicle energy recovery apparatus, which comprises an air capture unit having a mounting assembly for mounting the air capture unit on the moveable vehicle in a position to capture oncoming air when the moveable vehicle is in motion, a fan rotatably mounted in the air capture unit, a generator coupled to the fan and operative to rotate in response to rotation of the fan and to generate power, and an electrical conduction line for conducting power from the generator to a destination electrical load on the moveable vehicle.

Preferably, the fan has a horizontally disposed axis.

Advantageously, there may be a plurality of fans rotatably mounted in the air capture unit.

The fans may be mounted in a row on vertically disposed axes.

In another aspect of the invention there is provided a moveable vehicle having an energy recovery apparatus, which includes an air capture unit mounted on the moveable vehicle in a position to capture oncoming air when the moveable vehicle is in motion, a fan rotatably mounted in the air capture unit, a generator coupled to the fan and operative to rotate in response to rotation of the fan and to generate power and a line coupled at one end to the generator and at another end to a destination on the moveable vehicle.

Preferably, there are a plurality of fans rotatably mounted in the air capture unit.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a side view of a set of horizontally oriented fans and enclosure of a type suitable for use in the energy recovery system;

FIG. 2 is a front view of a set of horizontally oriented fans and enclosure of FIG. 1;

FIG. 3 is a side view of a truck with an installed energy recovery system installed both on a trailer and behind the grill;

FIG. 4 is a side view of an automobile with an energy recovery system installed behind the grill or under the hood;

FIG. 5 is a perspective view of a set of vertically oriented fan blades aligned in a row and an enclosure of a type suitable for use in the energy recovery system;

FIG. 6 is a top view of a set of vertically aligned fan blades, spaced apart and aligned in a row;

FIG. 7 is a side elevation view of an alternative fan which discharges air at an angle of more than 90 degrees relative to the direction of the incoming air; and

FIG. 8 is a schematic view of a duct used to direct incoming air to a remotely located fan and generator.

### DETAILED DESCRIPTION WITH REFERENCE TO THE DRAWINGS

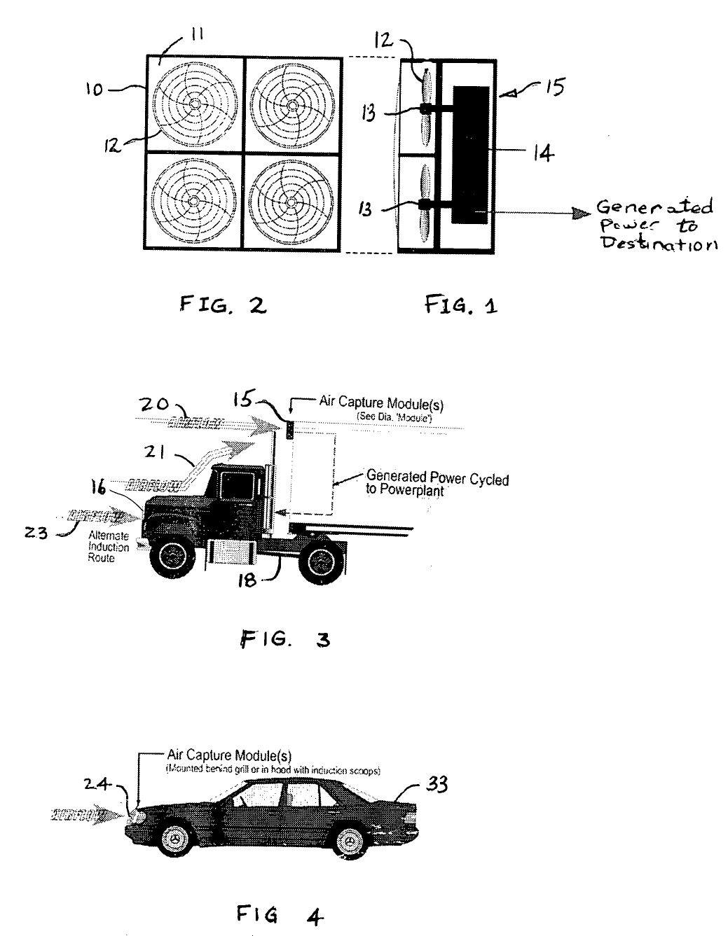

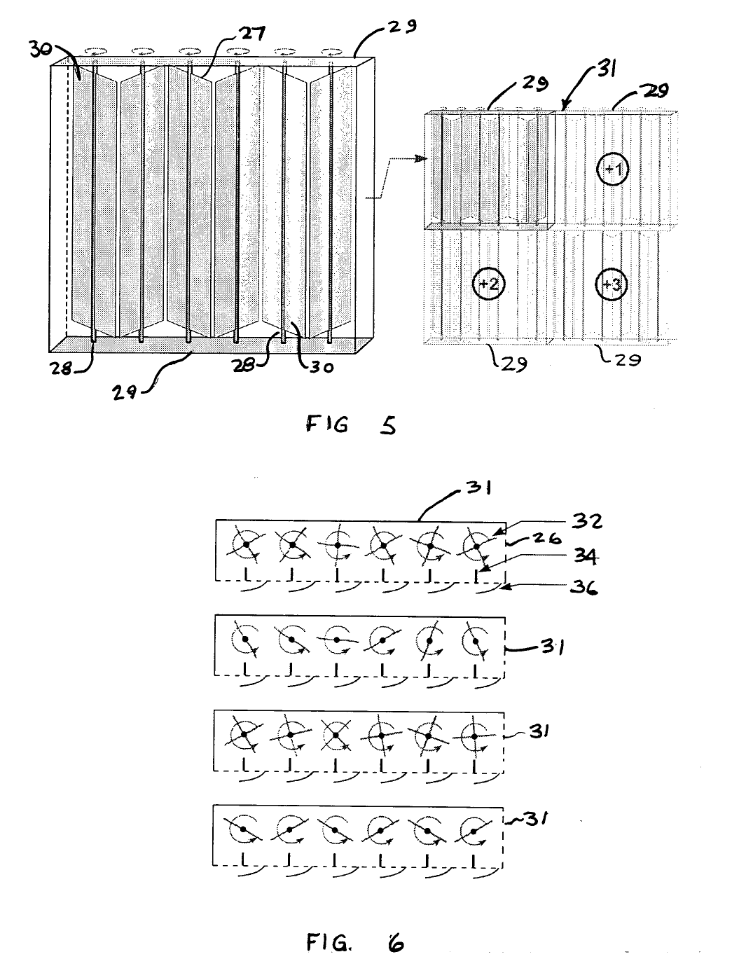

Referring to FIGS. 1 and 2, the air capture unit 15, which is mounted on an exposed position facing upwind on a movable vehicle (see FIGS. 3 and 4), consists of a square enclosure 10 having four square compartments 11. In each compartment 11 there is centrally positioned a fan 12 rigidly affixed to a rotatable shaft 13. The shaft 13 couples to a generator 14 an armature of which (not shown), rotates in response to rotation of shaft 13. Power generated by the generator 14 is taken off and used on the vehicle to reduce fuel consumption.

Referring to FIG. 3, a truck 16 has the air capture unit 15 mounted either on the front of a trailer (not shown) carried by the truck 16 where it can intercept oncoming wind 20 and 21 or in the front of the truck 16 behind the grill (not shown) facing wind 23. On an automobile 33 the air capture unit 15 is mounted either behind the grill 24 or under the hood where it is provided with induction scoops (not shown) in order to channel the oncoming wind into the unit 15.

Referring to FIG. 5 a set of fans 27 are made up of vertically oriented fan blades 30 are mounted in a row on rotatable rods 28 in rectangular enclosure 29. The enclosure 29 is combined with three other similar enclosures 29 to make an air capture unit 31. Referring to FIG. 6, four air capture units 31 are mounted together spaced apart as shown. Each unit 31 has a plurality of induction scoops 36 to intercept oncoming air into the unit 31 and a plurality of internal air deflectors 34 to block air from hitting both sides of each fan 27. Air leaves the unit through the end wall 26, which is permeable.

In operation, with truck 16 or automobile 33 in motion, oncoming air enters the air capture unit 15 or 31 and causes the fans 12 or 27 to rotate. The rotation of the fans is coupled to a generator 14 and causes the generator 14 to rotate. Rotation of the generator generates power, which is taken off and used by the vehicle. Obviously, there are many different fan designs which could work. Additionally, by combining a greater number of fans 12 or 27 into a compartment 11 or enclosure 29 a greater amount of power will be generated for a given wind velocity. It is also obvious that the speed of rotation of the fans 12 and 27 will vary according to speed. The energy recovery apparatus can be used on any moveable vehicle that generates sufficient speed including boats, trains, airplanes and the like.

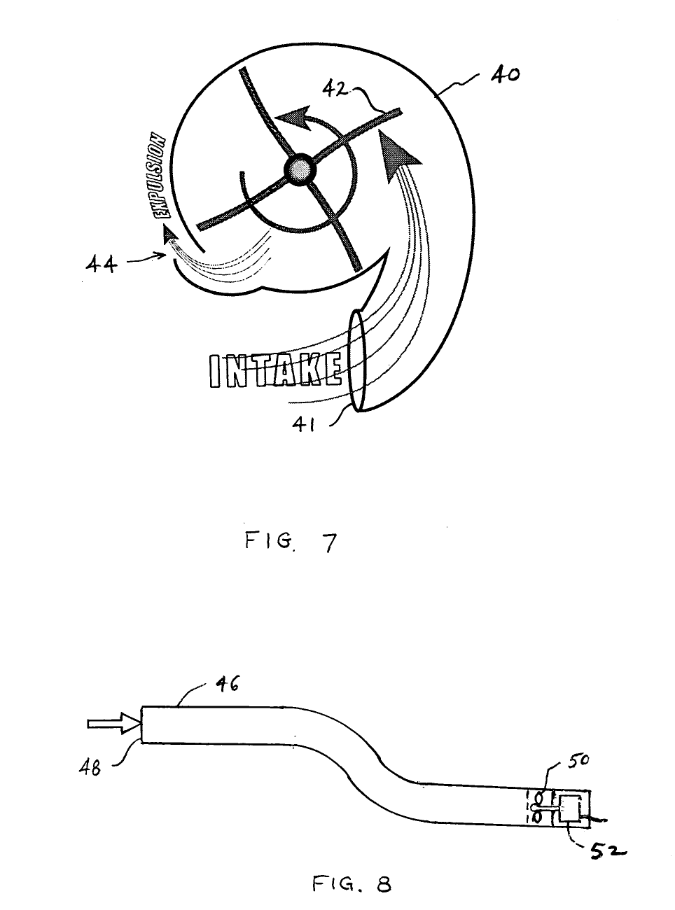

Referring to FIG. 7, an alternative fan 40 takes in air at mouth 41 directs it upwardly (as seen in the drawing) where it impacts the fan blades 42 and moves counterclockwise until it is discharged out of exhaust 44 at an angle of about 120 degrees to the direction of the incoming air. The advantage of such an alternative fan 40 is that it can discharge air in a direction not in-line with the incoming air that may be convenient given the geometry of its location.

Referring to FIG. 8 a long duct 46 receives incoming air at its moutn 48 which it directs to a remotely located fan 50. Fan 50 drives a generator 52. Using such ducting one can locate the fan and generator at the most convenient location on the vehicle. One can also use multiple ducts to increase the volume of air received in order to increase the fan speed and hence the power generated by the generator 52.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A moveable vehicle energy recovery apparatus, comprising:
(a) an air capture unit having a mounting assembly for mounting on said moveable vehicle in a position to capture oncoming air when said moveable vehicle is in motion;
(b) a fan rotatably mounted in said air capture unit at a location where it is driven by the incoming air;
(c) generator coupled to said fan and operative to rotate in response to rotation of said fan and to generate power;
(d) an electrical coupler couplable at one end to said generator and at another end to a destination power load.

2. The apparatus of claim 1, wherein said fan has a horizontally disposed axis.

3. A moveable vehicle energy recovery apparatus, comprising:
(a) an air capture unit having a mounting assembly for mounting on said moveable vehicle in a position to capture oncoming air when said moveable vehicle is in motion;
(b) a plurality of fans rotatably mounted in said air capture unit;
(c) a generator coupled to said fans and operative to rotate in response to rotation of said fans and to generate power; and
(e) an electrical energy conduction line couplable at one end to said generator and at another end to a destination power load on said moveable vehicle.

4. The apparatus according to claim 3, wherein said fans are mounted on vertically disposed axes and are disposed in a row.

5. The apparatus according to claim 3, wherein said fans are mounted on vertically disposed axes and are disposed in a plurality of spaced apart rows.

6. A moveable vehicle having an energy recovery apparatus, said energy recovery apparatus comprising:
(a) an air capture unit mounted on said moveable vehicle in a position to capture oncoming air when said moveable vehicle is in motion;
(b) a fan rotatably mounted in said air capture unit in a position to be driven by the incoming air;
(c) a generator coupled to said fan and operative to rotate in response to rotation of said fan and to generate power; and
(a) an electrical energy conduction line coupled at one end to said generator and at another end to a destination electrical load on said moveable vehicle.

7. The moveable vehicle according to claim 6, wherein said fan rotates about a vertical axis.

8. A moveable vehicle having an energy recovery apparatus, said energy recovery apparatus comprising:
(a) an air capture unit mounted on said moveable vehicle in a position to capture oncoming air when said moveable vehicle is in motion;
(b) a plurality of fans rotatably mounted in said air capture unit;
(c) a generator coupled to said fans and operative to rotate in response to rotation of said fans and to generate power; and
(b) an electrical energy conduction line coupled at one end to said generator and at another end to a destination load on said moveable vehicle.

9. The apparatus of claim 8, wherein said fans rotate about a vertical axis and are aligned in a row parallel to a directon of travel of said vehicle.

10. The apparatus of claim 8, wherein said fans rotate about a vertical axis and are aligned in a plurality of spaced apart rows parallel to a direction of travel of said vehicle.

11. A moveable vehicle having an energy recovery apparatus, said energy recovery apparatus comprising:
(c) a fan mounted on said vehicle in a position in which passing air caused by movement of said vehicle causes said fan to rotate;
(d) a generator coupled to said fan and operative to rotate in response to rotation of said fan and to generate power; and
(e) a power line coupled at one end to an output of said generator and another end to a destination load on said moveable vehicle.

12. The moveable vehicle according to claim 11, wherein said fan rotates about a vertical axis.

13. The moveable vehicle according to claim 11, wherein said fan moves said incoming air in a curvilinear path and discharges it at an angle to the incoming air.

14. The moveable vehicle according to claim 11, including an elongated duct having a mouth to receive incoming air and operative to direct the incoming air to a remotely located fan.

15. A method or energy recovery for a moveable vehicle, comprising:
(a) capturing oncoming air resulting from movement of a moveable vehicle and directing the captured air into a fan;
(b) coupling the fan to a generator so that rotation of the fan causes rotation of the generator and consequent generation of power; and
(c) conducting the power to a destination load on the moveable vehicle.

16. The method of claim 15, wherein said incoming air is captured by a duct leading to said fan.
